(19) United States
(12) Patent Application Publication
(10) Pub. No.: US 2004/0023005 A1
(43) Pub. Date: Feb. 5, 2004

(54) Vent cover

(76) Inventor: Vivian G. Perez, Fairfield, CT (US)

Correspondence Address: BLANK ROME LLP, 600 NEW HAMPSHIRE AVENUE, N.W., WASHINGTON, DC, 20037, US

(21) Appl. No.: 10/207,872

(22) Filed: Jul. 31, 2002

(51) Int. Cl. B32B 23/02

(52) U.S. Cl. 428/192

(57) ABSTRACT

The present invention relates to a cover for closing a vent of a building, which is particularly useful for covering air conditioning vents to prevent heat loss and/or air leakage. The vent cover of the present invention comprises a sheet, preferably of a polymeric material such as polyvinyl chloride (PVC). The sheet has sink key hole slides adjacent to the side edges so that fasteners, such as screws, can be used to secure the cover in place. In a preferred embodiment, the cover is adjustable such that its size can be adjusted to accommodate different vent sizes. The adjustable cover comprise at least two adjustable members that snaps together to form the cover. When the two adjustable members snap together, they form a cover having sink keyhole slides and/or flaps. However, the size of the resulting cover is adjustable by sliding the two halves toward or away from each other. The size is decreased by sliding the two halves toward each other; and the size is increased by sliding the two halves away from each other.

### FIELD OF THE INVENTION

The present invention relates to a cover for closing a vent of a building. The cover is particularly useful for covering air conditioning vents to prevent heat loss and/or air leakage.

### DESCRIPTION OF RELATED ART

The prior art has described numerous types of closures for vents and the like for buildings, particularly houses. In general, the closures are covers which block the vent and which are held in place by various types of connectors between the cover and the building or the vent.

U.S. Pat. No. 3,232,205 to Bumstead discloses a vent cover for preventing heat loss. The cover has projections and clamp that hold the cover in place. The projections and clamp hook onto the space between the wall/ceiling and the frame of the vent.

U.S. Pat. No. 2,834,278 to Crute, Jr. discloses a box-shaped, rectangular vent cover having a sleeve through the center of the cover. The cover is held in place with a bolt inserted into the sleeve. The bolt has a hook on one end, which hooks onto the grill of the vent. The other end of the bolt engages a wing nut which tightens to secure the cover in place.

U.S. Pat. No. 2,821,895 to Allabaugh discloses a rectangular vent cover having holes adjacent to the four corners. The cover is held in place by spring loaded hooks inserting through the holes. On one end, the hook attaches to the wire mesh screen covering the vent. On the other end, the hook is biased outward with a spring to secure the cover in position.

Other illustrative patents are U.S. Pat. No. 6,149,514 to Maury, U.S. Pat. No. 5,192,244 to Rose, U.S. Pat. No. 4,469,018 to Taulman, U.S. Pat. No. 3,130,659 to Compton et al., U.S. Pat. No. 3,115,082 to Sanoff, U.S. Pat. No. 2,843,035 to Jacks, and U.S. Pat. No. 978,718 to Ellington.

The problems with the prior art devices are that they are relatively expensive and that they are pre-fabricated for a particular size. Because vent openings come is a variety of shapes and sizes, a pre-fabricated cover does not conveniently meet the needs of suppliers and consumers. Thus, there is a need for an improved cover that is inexpensive and enables flexibility in fitting vents of different sizes.

### SUMMARY OF THE INVENTION

It is an object of the present invention to provide a vent cover that is easy to install and maintain, and inexpensive. The vent cover can be disposed directly over the vent grill to prevent heat loss from a conditioned space, such as a room or a house. The present invention is particularly useful in preventing heat loss in homes that has baseboard heating where the heat tends to rise and escapes through an air conditioning vent located in the ceiling or near the top of the wall.

The vent cover of the present invention comprises a sheet, preferably of a polymeric material such as polyvinyl chloride (PVC). The sheet has sink key hole slides adjacent to the side edges so that fasteners, such as screws, can be used to secure the cover in place. If there is a ventilation grill, the sink keyhole slides are preferably located at the screw locations of the ventilation grill so that the same fasteners that hold the grill in place can also be used to hold the vent cover in place. In a preferred embodiment, the cover also has flaps that can be inserted between the ventilation grill and the wall to form a secured fit.

A further embodiment of the present invention provides an adjustable cover whose size can be adjusted to accommodate different vent sizes. The adjustable cover comprise at least two adjustable members that snaps together to form the cover. When the two adjustable members snap together, they form a cover similar to that described previously, i.e. having sink keyhole slides and/or flaps. However, the size of the resulting cover is adjustable by snapping the two halves toward or away from each other. The size is decreased by sliding the two halves toward each other; and the size is increased by sliding the two halves away from each other. Maximum size is achieved when the two adjustable members have minimum overlap, while minimum size is achieved wherein the two adjustable members have maximum overlap.

### BRIEF DESCRIPTION OF THE DRAWINGS

The foregoing background and summary, as well as the following detailed description of the invention, will be better understood when read in conjunction with the appended drawings. For the purpose of illustrating the invention, there is shown in the drawings embodiments which are presently preferred. It should be understood, however, that the invention is not limited to the precise arrangements and instrumentalities shown. In the drawings:

FIG. 1 shows the plan view of a vent cover in accordance with the invention.

FIG. 2 shows the side view (from direction A) of the cover.

FIG. 3 shows the plan view of the two sheets of an adjustable vent cover in accordance with the invention.

FIG. 4 shows the plan view of the adjustable cover.

FIG. 5 shows the side view (from direction D) of the cover.

FIG. 6 shows the side view (from direction E) of the cover.

FIG. 7 shows the cover mounted over a vent with a vent grill.

### DETAILED DESCRIPTION OF THE INVENTION

Throughout the drawings like reference numerals refer to like elements. The terms “top” and “bottom” are used to distinguished between the faces of the cover. The terms “left” and “right” are used to distinguished between the two adjustable members of the adjustable cover. The use of the terms does not mean that the cover will always be oriented with the “top” face above the “bottom” face or the “left” adjustable member to the left of the “right” adjustable member. Either positions of the cover are considered to be within the scope of the invention.

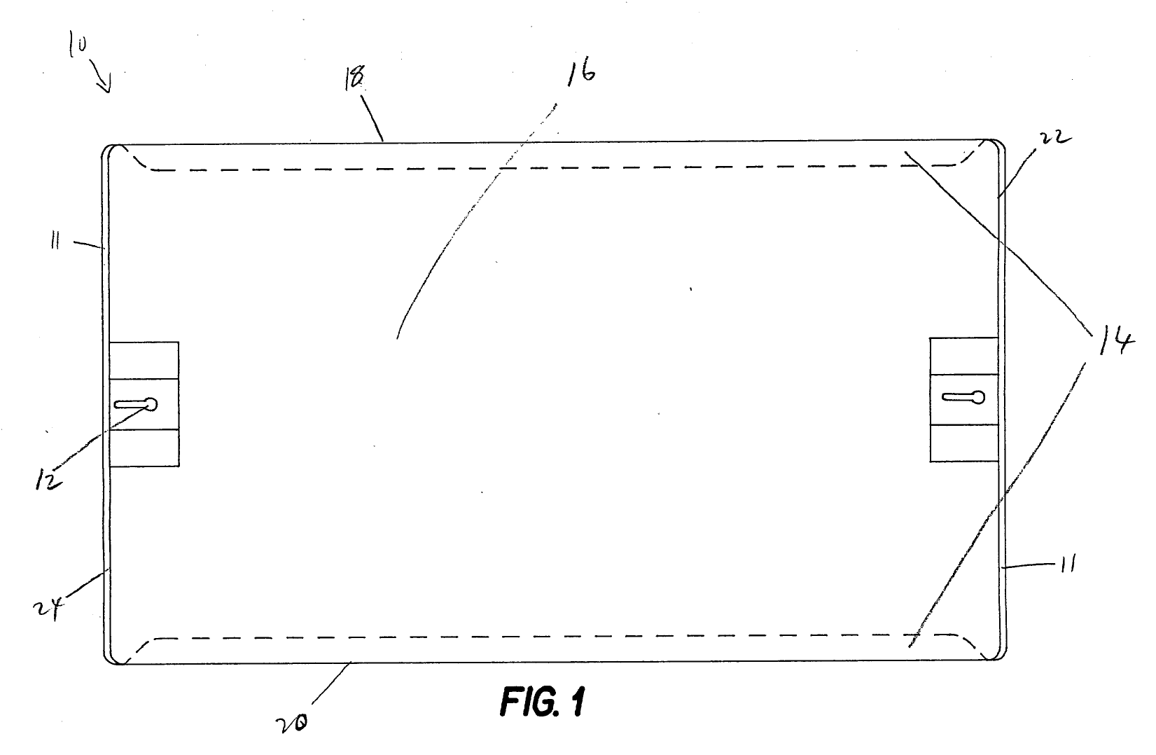

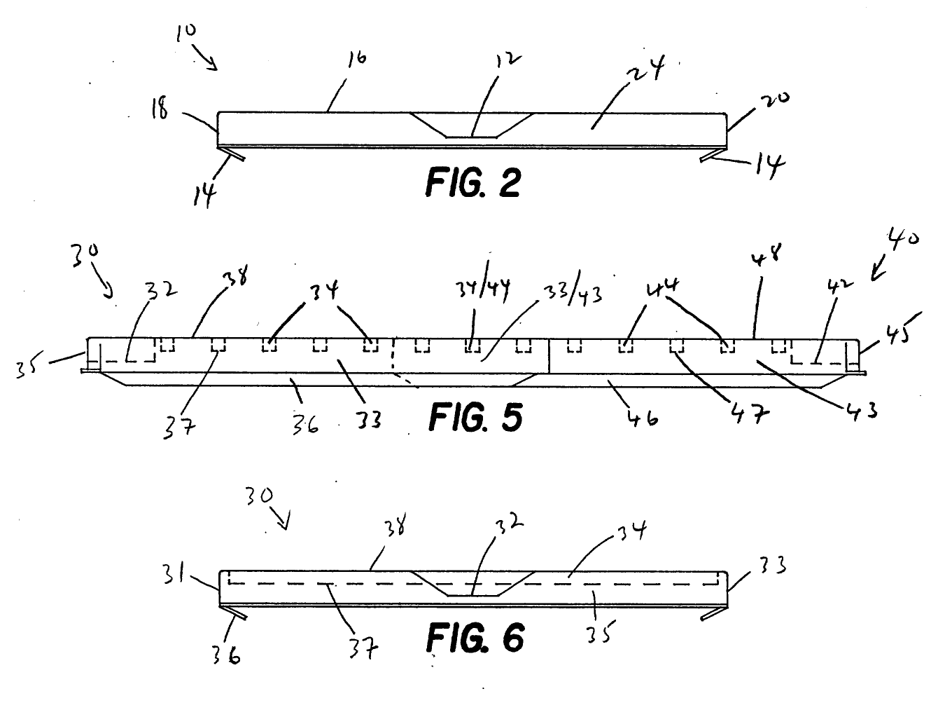

FIGS. 1-2 show an embodiment of the present invention. The cover (10) has a front face (16), a top face (18), a bottom face (20), and lateral faces (22, 24). The thickness of the top face (18), bottom face (20) and lateral faces (22, 24) are preferably the same and are much less than the width of the cover. Preferably, the thickness is about 1% to about 10% of the width, more preferably about 4% to about 8%, and most preferably about 5% to about 6%. Nevertheless, the thickness of the top face (18), bottom face (20) and lateral faces (22, 24) is preferably no more than 1 inch, more preferably from 0.25 inch to about 0.75 inch, and most preferably about 0.5 inch.

The vent cover is secured in place over a vent with fasteners, such as screws, nuts, bolts, rivets, etc. To facilitate the fastening, the cover preferably has at least two sink keyhole slides (12). Most often, the vent has a ventilation grill at the vent opening to direct air and/or to prevent excessive dust and debris from entering the ventilation system. The ventilation grill attaches to the wall and completely covers the vent opening. The attachment of the ventilation grill to the vent is usually accomplished with fasteners, most likely screws. In the event that a ventilation grill is present, the sink keyhole slides (12) are preferably located adjacent to the screw locations of the ventilation grill, so that the same fasteners can be used to secure both the ventilation grill and the vent cover. Most likely, the screw locations are adjacent to the middle of the lateral faces (22, 24) as shown in FIG. 1.

In a preferred embodiment, the vent cover has flaps (14). The flaps (14) are extensions of the top face (18) and bottom face (20) that are folded inward toward the center of the vent cover (10).

In another preferred embodiment, the vent cover has extensions (11) extending from lateral surfaces (22, 24) to better seal the cover against the wall when the vent cover is installed. The extensions (11) are preferably folded outward from the center of the vent cover (10).

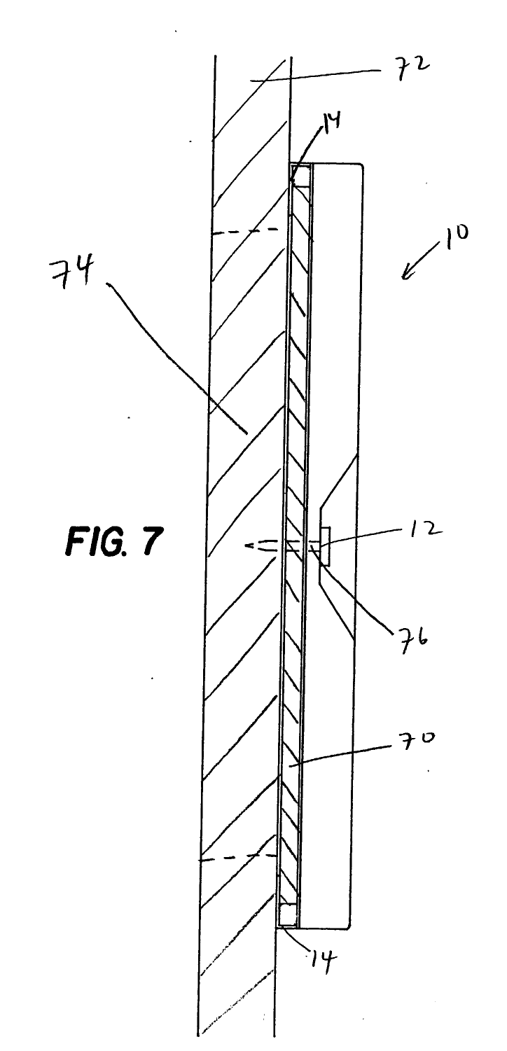

FIG. 7 shows the vent cover (10) installed over a vent opening (74) having a ventilation grill (70). When the cover is installed over a vent opening (74), the flaps (14) are inserted between the wall (72) and ventilation grill (70) to secure the cover in place (see FIG. 7). A fastener (76), such as a screw, is then inserted through the sink keyhole slides (12) and fastened to the wall (72) to secure the cover to the in place. Installation of the vent cover simply requires loosening or removing the fasteners holding the ventilation grill, placing the cover over the grill (if the flaps (14) are present, it should be inserted between the grill and the wall), and reinstalling the fasteners. If no ventilation grill is present, the cover is simply placed over the vent opening (74) and fastened to the wall.

The cover is preferably constructed of a polymeric material, which can be, but is not limited to polyvinyl chloride (PVC), polyethylene, polyethylene terephthalate, polypropylene, polystyrene, polycarbonate, acrylic, acrylonitrile butadienne styrene, cellulose acetate, cellulose propionate, cellulose acetate butyrate, and mixture thereof. The preferred polymeric material is amenable to thermoforming. The polymeric material preferable has a thickness of about 18 to about 26 mils, more preferably about 20 to about 24 mils, and most preferably about 22 mils.

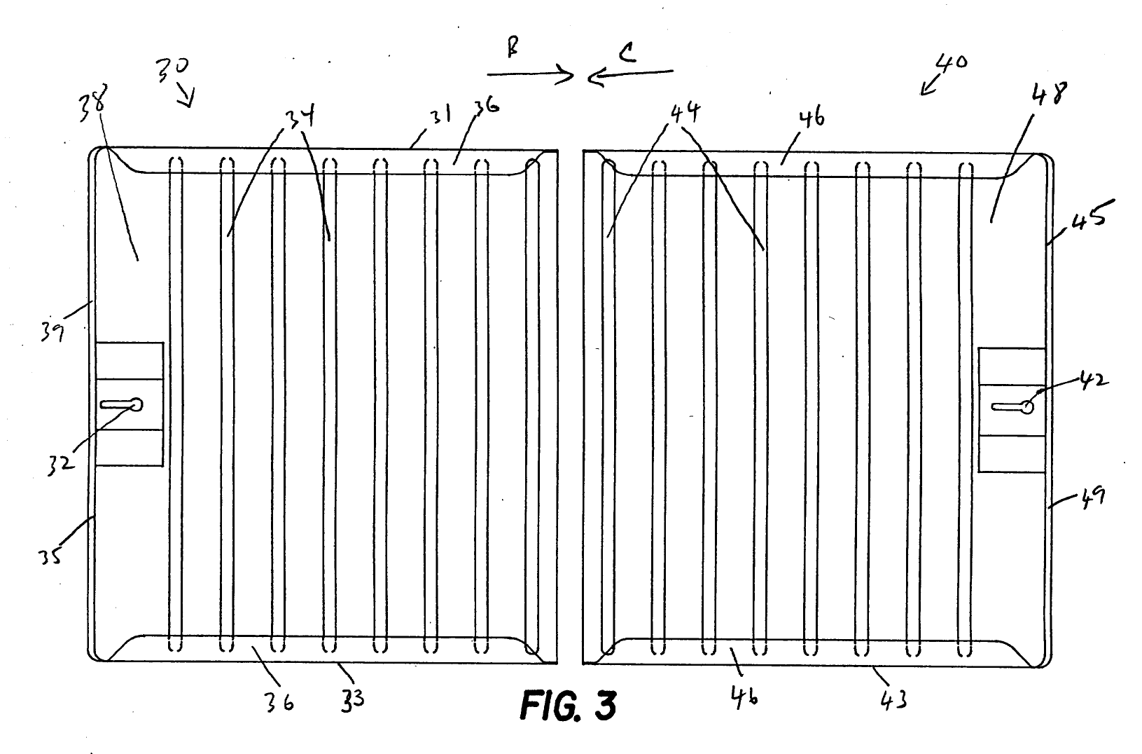

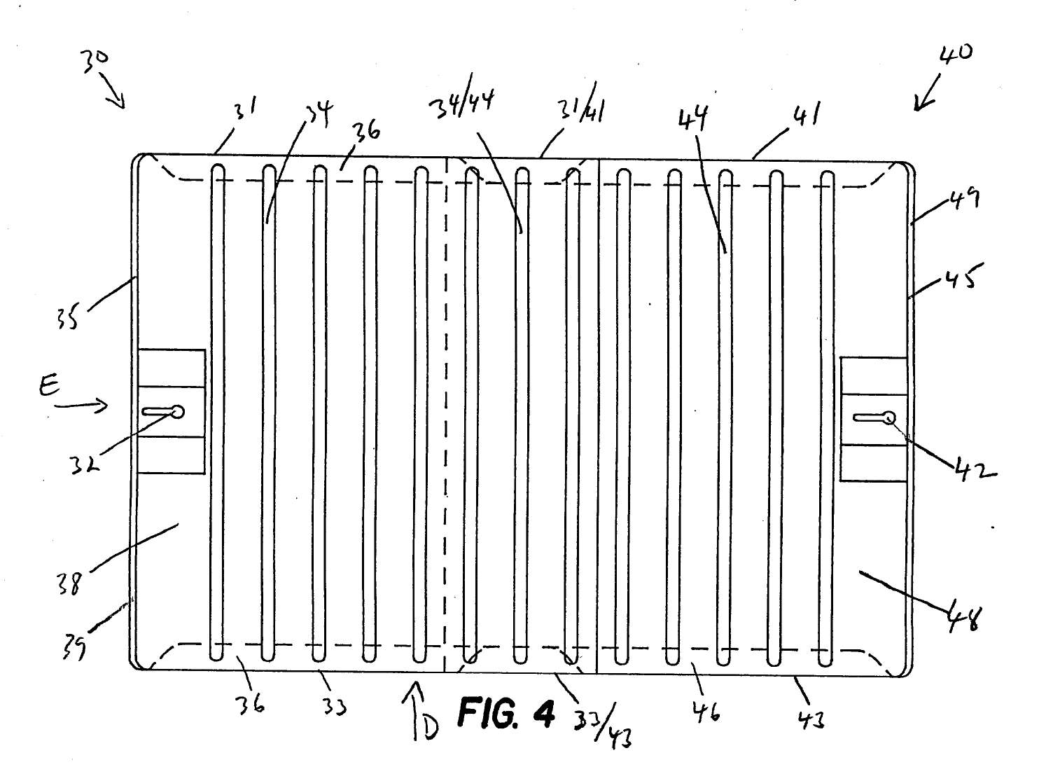

In another embodiment of the invention, the cover is adjustable to fit the size of the vent opening and/or the ventilation grill. The simplest adjustable cover comprises two adjustable members (30, 40) as shown in FIG. 3. FIG. 3 shows a left adjustable member (30) and a right adjustable member (40) of the adjustable cover; FIG. 4 shows the assembled adjustable cover; FIG. 5 shows the side view from direction D of the adjustable cover; and FIG. 6 shows the side view from direction E of the adjustable cover.

To assemble the adjustable cover, the two adjustable members (30, 40) slide together along their front faces (38, 48). This is accomplish by sliding the left adjustable member (30) in direction B and the right adjustable member (40) in direction C. When the two adjustable members are assembled they are preferably locked in place with channels (34, 44). The channels (34, 44) are shaped into the front faces (38, 48) such that they form depressions on the front faces (38, 48) and projections on the back faces (37, 47) of the two adjustable members (see FIGS. 5 and 6). When the two adjustable members (30, 40) are assembled, the channels (34, 44) snaps into each other to hold the two adjustable members (30, 40) in place. By snapping together, the projection on the back face of an adjustable member fits into the depressions on the front face of the other adjustable member. For example, in FIGS. 4-5, where the two adjustable members over lap, the channels over lap each other and the channels from the adjustable members snap into each other to form a lock (34/44). In snapping together, one channel fits directly into the other channel.

Each adjustable member preferably has a plurality of spaced apart channels (34, 44). The spacing between the channels (34, 44) can be about 0.2 to about 2 inches, preferably about 0.5 to about 1.5 inches, and most preferably about 1 inch. Channels are preferred, but are not required by the present invention. The adjustable cover may not have any channels at all.

Once assembled the cover can be used similar to the cover (10) depicted FIG. 1. The assembled adjustable cover also has sink keyhole slides (32, 42) to accommodate fasteners.

In the configuration shown in FIGS. 3-6, the length of the cover can be adjusted in direction D by sliding the two adjustable members (30, 40) toward or away from each other. Sliding the two adjustable members (30, 40) toward each other reduces the length and increases the over lap; and sliding the two adjustable members (30, 40) away from each other increases the length decreases the overlap. Thus, maximum size is achieved when the two adjustable members (30,40) have minimum overlap, while minimum size is achieved wherein the two adjustable members (30, 40) have maximum overlap.

In a preferred embodiment, the adjustable cover also has flaps (36, 46) to be inserted between the wall and ventilation grill. The flaps (36, 46) are similar to those described previously for the cover (10) depicted in FIGS. 1-2. The flaps (36, 46) are extensions of the top faces (31, 41) and bottom faces (33, 43) of each of the adjustable members (30, 40), which are folded inward toward the center of the cover. These flaps (36, 46) are inserted between the wall and the ventilation grill as shown for the flaps (14) in FIG. 7.

In another preferred embodiment, the vent cover has extensions (39, 49) extending from lateral surfaces (35, 45) to better seal the cover against the wall when the vent cover is installed. The extensions (39, 49) are preferably folded outward from the center of the vent cover.

Although the adjustable cover disclosed herein contains only two adjustable members and can only be adjusted in one dimension, it is possible, based on the instant disclosure, to design an adjustable vent cover that has four adjustable members that allow size adjustment in two dimensions. Other configurations containing more than two adjustable members are also contemplated.

Although certain presently preferred embodiments of the invention have been specifically described herein, it will be apparent to those skilled in the art to which the invention pertains that variations and modifications of the various embodiments shown and described herein may be made without departing from the spirit and scope of the invention. Accordingly, it is intended that the invention be limited only to the extent required by the appended claims and the applicable rules of law.

What is claimed is:

1. A cover for covering a vent, said cover comprising a sheet being of a size and shape to completely cover the vent, said sheet having at least two sink keyhole slides matching at least two different screw locations of a ventilation grill.

2. The cover of claim 1, wherein said cover further comprising flaps insertable between the ceiling and the ventilation grill.

3. The cover of claim 1, wherein said cover is constructed of a polymeric material.

4. The cover of claim 3, wherein said polymeric material is polyvinyl chloride (PVC).

5. The cover of claim 4, wherein the PCV is from about 18 to about 26 gauge.

6. An adjustable cover for covering a vent having a size, said cover comprising at least two sheets, each sheet having at least one sink keyhole slide matching at least one screw location of a ventilation grill, said at least two sheets being slidable along adjacent surfaces so that the cover can be adjusted to fit the size of the vent.

7. The adjustable cover of claim 6, wherein the at least two sheets having channels to lock the relative position of the at least two sheets in place.

8. The adjustable cover of claim 6, wherein each of said at least two sheets having flaps insertable between the ceiling and the ventilation grill.

9. The adjustable cover of claim 6, wherein said cover is constructed of a polymeric material.

10. The adjustable cover of claim 9, wherein said polymeric material is polyvinyl chloride (PVC).

11. The adjustable cover of claim 10, wherein the PCV is from about 18 to about 26 gauge.

12. A method for covering a vent comprising
providing the cover of claim 2;
loosening or removing fasteners holding the ventilation grill in place;
placing the cover over the vent;
inserting the flaps between the wall and the ventilation grill; and
attaching the cover over the vent by tightening the fasteners.

13. The method of claim 12, wherein said cover is constructed of a polymeric material.

14. The method of claim 13, wherein said polymeric material is polyvinyl chloride (PVC).

15. The method of claim 14, wherein the PCV is from about 18 to about 26 gauge.

16. A method for covering a vent comprising
providing the adjustable cover of claim 7;
adjusting the size of the cover to match the size of the vent;
loosening or removing fasteners holding the ventilation grill in place;
placing the cover over the vent;
inserting the flaps between the wall and the ventilation grill; and
attaching the cover over the vent by tightening the fasteners.

17. The method of claim 16, wherein each of said at least two sheets having flaps insertable between the ceiling and the ventilation grill.

18. The method of claim 16, wherein said cover is constructed of a polymeric material.

19. The method of claim 19, wherein said polymeric material is polyvinyl chloride (PVC).

20. The method of claim 20, wherein the PCV is from about 18 to about 26 gauge.
